(19) United States
(12) Patent Application Publication
(10) Pub. No.: US 2025/0037343 A1
(43) Pub. Date: Jan. 30, 2025

(54) Guided Multimodal Virtual Try-On

(71) Applicant: Google LLC, Mountain View, CA (US)

(72) Inventors: Garima Pruthi, San Jose, CA (US); Arjun Akula, Sunnyvale, CA (US)

(21) Appl. No.: 18/226,433

(22) Filed: Jul. 26, 2023

(51) Int. Cl. G06T 13/80; G06T 13/20; G06T 13/40

(52) U.S. Cl. CPC G06T 13/80; G06T 13/205; G06T 13/40

(57) ABSTRACT

The technology is generally directed to using a machine learning model to generate a visualization of an intended wearer wearing one or more source garments by preserving the appearance and shape of the intended wearer and garments, even when the pose and/or environmental details are adjusted based on natural language inputs. The model may include a plurality of layers, each conditioned to warp a different type of garment, adjust the pose of the intended wearer, adjust the environmental details in the output image, etc. The plurality of layers may allow for the garments to be warped simultaneously, as compared to sequentially. When executing the model, the model may receive input images and/or natural language inputs corresponding to the intended wearer, garments, pose, environmental details, or the like. The output of the model may be a realistic visualization of the intended wearer wearing the input garments in an intended pose.

### BACKGROUND

When viewing garments on a publisher's website, the garments are typically displayed on a preselected wearer. The preselected wearer does not typically represent the user visiting the publisher's website. This may leave the user unsure of how the garments would look if worn by the user. Further, the pose of the preselected wearer is typically irrelevant to the type of garments, intended wear situations of the garments, or the like such that it is difficult for a user to visualize how the garments would look in a certain environment.

Some publisher's websites have the option to allow the user to upload an image of themselves such that the user can visualize the garments on themselves. However, the transfer of garments to the image of the user typically retains the pose of the user in the picture and, therefore. leads to poor visualization of the garments.

### BRIEF SUMMARY

The technology is generally directed to using a machine learning model to generate a visualization of an intended wearer wearing one or more source garments by preserving the appearance and shape of the intended wearer and garments, even when the pose and/or environmental details are adjusted based on natural language inputs. For example, the model may include a plurality of layers, each conditioned to warp a different type of garment, adjust the pose of the intended wearer, adjust the environmental details in the output image, etc. The plurality of layers may allow for the garments to be warped simultaneously, as compared to sequentially. When executing the model, the model may receive input images and/or natural language inputs corresponding to the intended wearer, garments, pose, environmental details, or the like. The output of the model may be a realistic visualization of the intended wearer wearing the input garments in an intended pose.

One aspect of the disclosure is directed to a method, comprising receiving, by one or more processors from a user device, inputs including natural language inputs corresponding to a description of a wearer pose and at least one intended garment and executing, by the one or more processors based on the received inputs, a machine learning model. The executing may comprise adjusting a pose of a wearer based on the natural language inputs corresponding to the description of the wearer pose and conditioning, using a respective machine learning layer of the machine learning model, the at least one intended garment to the adjusted pose of the wearer. The method may further comprise providing for output on the user device, by the one or more processors, the at least one intended garment on the wearer in the wearer pose.

When the at least one intended garment includes two or more intended garments, each of the two or more intended garments may be conditioned simultaneously to the adjusted pose of the wearer. Executing the machine learning model may further comprise simultaneously conditioning, using respective machine learning layers of the machine learning model, the two or more intended garments to the adjusted pose of the wearer, the respective machine learning layers being different machine learning layers.

The natural language inputs may further include environmental details, and wherein the output further includes an environment for the wearer based on the environmental details. The environmental details may correspond to at least one of lighting, texture, background, color, angle, or image filter. Executing the machine learning model may further comprise adjusting an output environment based on the natural language inputs corresponding to the environmental details.

The machine learning model may comprise one or more machine learning layers. Each machine learning layer may correspond to a type of garment. Each machine learning layer, when executed, may provide as output a corresponding garment layer. The type of garment may include at least one of a lower body garment, an upper body garment, an accessory, or shoes. Executing the machine learning model may further comprise ordering the garment layers based on the received input.

The method may further comprise receiving, by the one or more processors, second input and executing, by the one or more processors based on the received second input, the machine learning model. Executing the machine learning model may further comprise adjusting a depiction of a second garment in a second garment layer based on the second input. Adjusting the second garment in the second garment layer may not change the depiction of the at least one intended garment in a first garment layer. The second input may include at least one of: an addition of a second intended garment, removal of the intended garment, or an adjustment of an order of the layers of the at least one intended garment.

Another aspect of the disclosure is directed to a system, comprising one or more processors. The one or more processors may be configured to receive, from a user device, inputs including natural language inputs corresponding to a description of a wearer pose and at least one intended garment and execute, based on the received inputs, a machine learning model. The executing may comprise adjusting a pose of a wearer based on the natural language inputs corresponding to the description of the wearer pose and conditioning, using a respective machine learning layer of the machine learning model, the at least one intended garment to the adjusted pose of the wearer. The one or more processors may be further configured to provide for output on the user device, by the one or more processors, the at least one intended garment on the wearer in the wearer pose.

Yet another aspect of the disclosure is directed to a non-transitory computer-readable medium storing instructions, which when executed by one or more processors, cause the one or more processors to receive, from a user device, inputs including natural language inputs corresponding to a description of a wearer pose and at least one intended garment and execute, based on the received inputs, a machine learning model. The executing may comprise adjusting a pose of a wearer based on the natural language inputs corresponding to the description of the wearer pose and conditioning, using a respective machine learning layer of the machine learning model, the at least one intended garment to the adjusted pose of the wearer. The one or more processors may be further configured to provide for output on the user device, by the one or more processors, the at least one intended garment on the wearer in the wearer pose.

### BRIEF DESCRIPTION OF THE DRAWINGS

FIG. 1 is an example use of a virtual try on system according to aspects of the disclosure.

FIG. 2 is a block diagram of a virtual try on system according to aspects of the disclosure.

FIG. 3 is a block diagram of an example environment for implementing the virtual try on system according to aspects of the disclosure.

FIG. 4 is an example method of simultaneously conditioning garments on a wearer based on inputs according to aspects of the disclosure.

### DETAILED DESCRIPTION

The technology is generally directed to using a machine learning model to virtually try on garments. The machine learning model may have different stages, networks, or layers. Each layer may be trained for a different type of garment, such as lower body garments, upper body garments, accessories, or the like. According to some examples, the model may include layers trained for different brands, emotions, poses, or the like. The use of different networks may allow for multiple garments to be conditioned, or warped, to the pose of the wearer simultaneously. Conditioning garments may include, for example, adjusting the appearance of the garment based on the intended wearer and an intended pose. The adjustments may include, for example, an intended fit, flow, twist, wrinkle, etc. to represent how the intended wearer, in a given pose, would look when wearing the garment in said pose. According to some examples, the model may be trained to receive natural language inputs corresponding to the intended pose for the wearer, environmental changes, or the like. For example, the natural language inputs may guide the output of the model by adjusting the pose, lighting, background depiction, etc. corresponding to the inputs. The model may be trained to provide the model, in the intended pose, with the selected garments warped to the wearer's body.

In some examples, the model may be trained to provide certain lighting, angles, or the like to accentuate the garments, brands, emotions, pose, etc. For example, the model may be trained to identify the type of clothing, brands, intended environment, emotions, etc., based on the inputs provided to the model. Examples of the type of clothing may include formal wear, athleisure, business, etc. Examples of the type of intended environment may include outside, office, gym, restaurant, etc. Examples of the type of emotion may include happy, sad, serious, excited, etc. The inputs may be the garments and/or the natural language inputs. The model may be trained to provide an output that accentuates, highlights, etc. the inputs such that substantially corresponds to what the wearer would, could, and/or should look like in the garments under the input conditions.

The model may be a diffusion model that allows for the garments to be conditioned and, therefore, warped simultaneously through a U-Net model. For example, multiple garments may be provided as input into the model. Multiple encoded layers within the model may be used to condition the garments. For example, each layer may capture different parts or aspects of the input garments. The layers may be trained to warp the different garments to the pose of the wearer. In some examples, one or more layers may be trained to adjust the pose of the wearer based on natural language inputs. Additionally or alternatively, one or more layers may be trained to adjust the pose based on the brand, type of clothing, intended pose, intended emotions, or the like. For example, if the intended clothing is athleisure with a baseball hat and a pair of running shoes, the layers may be trained to determine that the wearer is likely to be running outside and, therefore, provide an output with lighting corresponding to the outdoors.

The wearer may be, in some examples, a predetermined wearer, a wearer selected by the user, or an image of the user themselves. The natural language inputs are provided into a model that concurrently warps the garments to the wearer and/or pose, rather than sequentially and separately warping all the garments.

The model may provide for cross-garment interactions. For example, based on the natural language inputs, the warped garments may or may not be tucked in, an accessory may lay a certain way on a selected, or the like. According to some examples, the model may be a diffusion model that allows for the described garments to be conditioned, e.g., warped simultaneously through a U-Net model. For example, multiple garments, including accessories, may be passed through the model using a plurality of different encoded layers. Each layer may capture different aspects of the input garments, such as the type of garment (e.g., a top, bottom, accessory), the intended fit of the garment, the coloring of the garment, the brand of the garment, or the like. Based on the different aspects of the garments, the garments may be simultaneously warped to the intended pose of the wearer.

By using a plurality of different layers within the model, the efficiency of the model may increase as compared to using a single layer to warp the garments. For example, each layer may be specifically trained to a given type of garment and/or input, such as the natural language inputs. In some examples, by using a plurality of different layers within the model to warp the garments, the garments may be simultaneously warped to the intended pose and the wearer simultaneously, rather than having to sequentially warp the garments. This may increase the computational efficiency by utilizing less resources, such as memory and processing power.

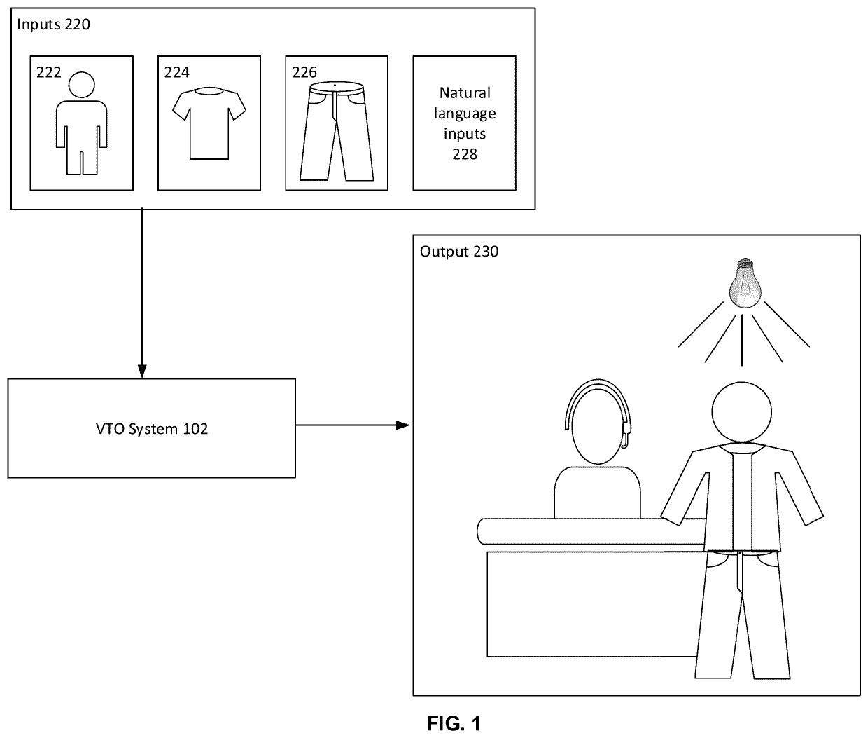

FIG. 1 illustrates an example use of a virtual try-on (“VTO”) system. The VTO system 102 may be a machine learning model that is configured to condition multiple garments simultaneously using a plurality of machine learning layers within the model. Conditioning garments may include, for example, altering the appearance of an input garment based on the intended wearer of the garment. For example, the input garment may be conditioned, or warped, to represent how the garment would appear on the intended wearing by adjusting the wrinkles, flow, twist, etc. of the input garment. A plurality of input garments may be conditioned simultaneously, with each garment being processed using a respective layer of the VTO system, such that the out output of the VTO system 102 may be a realistic visualization of an intended wearer having a plurality of garments layered based on one or more inputs and warped to an intended pose. For example, each machine learning layer may provide, as output, a corresponding garment layer. The garment layers may be ordered based on the inputs to the VTO system 102. One or more garments layers may be changed, adjusted, added, or removed, without changing previously output garment layers.

The VTO system 102 may receive one or more inputs 220. The inputs 220 may include a wearer 222, one or more garments 224, 226, and one or more natural language inputs 228.

The input 220 of a wearer 222 may be, in some examples, an image, a natural language input, or a selection of a wearer. In other examples, the input 200 of a wearer 222 may be a predefined wearer or default wearer, such as a wearer provided by a publisher. In some examples, the wearer may be selected by a user from a plurality of wearer options. such that a user may select the wearer option that most closely resembles the user or the user intended to wear the garments. In another example, the wearer 222 may be the user or the user intended to wear the garments. In such an example, the input 220 of the wearer 222 may be an image, such as a JPEG, PNG, or the like, of the user.

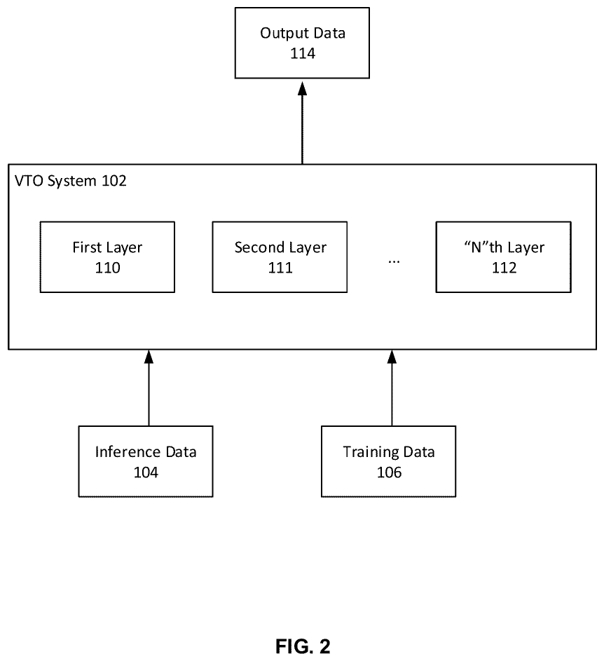

According to some examples, garments 224, 226 may be selectable garments. For example, a publisher may include a plurality of garments as options to be selected and provided as input into the VTO system 102. In some examples, the VTO system 102 may receive images of garments 224, 226 as inputs. In yet another example, the garments 224, 226 may be described via natural language inputs 228. For example, rather than providing an image or selection of garments, natural language inputs describing the garments may be provided as input. Accordingly, providing images of garments 224, 226 as inputs 220, as shown in FIG. 2, is just one example and is not intended to be limiting.

In some examples, the images depicting garments 224, 226 may be images of the garments being worn by another user. The VTO system 102 may be trained to preserve the intended visualization of the garment while warping the garment to the wearer 222 in the intended pose of the wearer 222.

The natural language inputs 228 may describe the wearer, garments, intended pose, environment details, or the like. For example, the natural language inputs 228 may be wearer 222 wearing a t-shirt, with an open jacket over the t-shirt and, the t-shirt tucked into jeans while standing at a desk under a light. In such an example, the VTO system 102 may identify the natural language input “standing at a desk” as the intended pose and “at a desk under a light” as the environmental details. In some examples, the VTO system 102 may identify the natural language input “an open jacket over the t-shirt” as an additional layer of garments to be conditioned to the intended wearer. According to some examples, each garment, e.g., t-shirt, jacket, pants, may be provided as a natural language input. Alternatively, the natural language inputs may supplement images provided of intended garments, e.g., the natural language input of “jacket” may supplement the images of garments 224, 226, the shirt and pants.

The natural language inputs 228 may provide for cross-modal interactions between the input garments, wearer, intended pose of the wearer, and environmental details. For example, the natural language inputs may be used to adjust the intended pose of the wearer, including the intended emotion of the wearer, rather than taking the pose of the wearer 222 as explicit input into the VTO system 102. The natural language inputs 228 may be used to adjust the output of the VTO system 102 by adjusting the pose, emotion, and environmental details such that the output is a realistic visualization of the wearer wearing the garments corresponding to the described conditions. The natural language inputs 228 may allow for aspects of the output to be changed, e.g., lighting, texture, background, object relationships, color, etc.

According to some examples, the VTO system 102 may condition all the input 220 together, simultaneously, such that the input garments 224, 226 and natural language inputs are warped together. In such an example, the garments 224, 226, e.g., shirt and pants, as well as the natural language input “open jacket” may be warped once, simultaneously, as compared to sequentially generating an output for each garment on top of a previously warped output. Each garment may be conditioned using a respective machine learning layer and provided, as output, as a corresponding respective garment layer. The garment layers may be ordered based on the inputs. For example, the t-shirt layer may be ordered before the pants layer due to the natural language input “tucked in.” In some examples, the jacket layer may be on top of, or ordered last, based on the input “over the t-shirt.” According to some examples, additional, subsequent inputs may be provided to reorder the garment layers, add new garments, change the pose, or the like. The additional inputs may not cause the depiction of the original garment layers to change but for adjusting the pose or unless the original garment layers are removed.

By simultaneously conditioning all the garments 224, 226 together using a plurality of machine learning layers of the VRO system 102, the VTO system 102 may provide for rich cross-garment interactions. Cross-garment interactions may include, for example, how the garments interact with one another once warped on the wearer. For example, cross-garment interactions may include how a shirt is tucked in, how a jacket is worn over a shirt, how garments fit or flow on the wearer, or the like. To provide for cross-garment interactions and simultaneous warping of garments, the VTO system 102 may use a diffusion model. The diffusion model may allow the conditioning on all garments simultaneously through a U-Net model. For example, the U-Net may be a parallel U-Net model with a plurality of machine learning layers. The machine learning layers may be configured to warp the garments to the wearer using cross attention. According to some examples, the model may include a respective machine learning layer for each type of garment. For example, the model may include a machine learning layer for conditioning jackets, a machine learning layer for conditioning shirts, a machine learning layer for conditioning pants, a machine learning layer for shoes, a machine learning layer for accessories, a machine learning layer for hats, etc. By having a plurality of machine learning layers, with each machine learning layer being trained to condition a specific type of clothing or accessory, the model may simultaneously condition each input to the intended wearer in a given pose, as compared to having to condition each garment separately.

After executing the VTO system 102 based on input 220, the VTO system 102 may provide an output. The output 230 may be, for example, an image. The image may correspond to the inputs 220 and/or be representative of the inputs 220. For example, continuing with the example above, the output 230 may be wearer 222 wearing jeans with a t-shirt tucked in and an open jacket over the t-shirt standing at a desk under a light. The t-shirt, e.g., garment 224, jeans, e.g., garment 226, and jacket may be conditioned, or warped, to the body of the wearer 222 such that the user can visualize how the garments 224, 226 on the user in a given environment with a given pose. For example, the garments may be conditioned to the wearer 222 in the given pose such that the garments are adjusted, altered, changed, etc. to provide the appearance of the intended fit, flow, hang, wrinkle, twist, or the like.

The VTO system 102 may allow the user to visualize how garments may appear on a wearer based on the inputs provided to the VTO system 102. For example, a user may intend to visualize how one or more garments appear on their body and, therefore, the user may provide an image of themselves as the intended wearer of the garments. In addition to an input of the intended wearer, the user may provide inputs corresponding to the garments, intended pose, environmental details, or the like. In some examples, the intended pose and/or environmental details may be inferred by the VTO system 102 based on the type of garments, brand of garments, etc. The multiple machine learning layers of the VTO system 102 may allow for the garments to be visualized on the intended wearer in a particular pose with specific environmental details by warping the garments simultaneously to the body of the intended wearer. This may provide for a computationally efficient and esthetically effective way to visualize the intended wearer wearing the garments.

In one example, one machine learning layer, e.g., an intended wearer layer, may receive the intended wearer image as input. Another machine learning layer, e.g., the garment layer, may receive garment images as input. The garment images may be, in some examples, segmented garment images. Pose embeddings may be determined by another machine learning layer based on the intended wearer, garments, and natural language inputs. The pose embeddings may be fused to intended wearer layer though an attention mechanism. The pose embeddings may be used to condition, warp, or modulate, features of the garments such that the output of the VTO system 102 is a realistic visualization of the intended wearer wearing the garments in a given pose.

FIG. 2 depicts a block diagram of an example guided multimodal virtual try-on (“VTO”) system 102, which can be implemented on one or more computing devices. The VTO system 102 may be a machine learning model. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some machine-learned models can include multi-headed self-attention models (e.g., transformer models). According to some examples, the VTO system 102 may be a diffusion model that is configured to condition multiple garments simultaneously through a U-Net model.

The model(s) can be trained using various training or learning techniques. The training can implement supervised learning, unsupervised learning, reinforcement learning, etc. The training can use techniques such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations. A number of generalization techniques (e.g., weight decays, dropouts, etc.) can be used to improve the generalization capability of the models being trained.

The model(s) can be pre-trained before domain-specific alignment. For instance, a model can be pretrained over a general corpus of training data and fine-tuned on a more targeted corpus of training data. A model can be aligned using prompts that are designed to elicit domain-specific outputs. Prompts can be designed to include learned prompt values (e.g., soft prompts). The trained model(s) may be validated prior to their use using input data other than the training data, and may be further updated or refined during their use based on additional feedback/inputs.

The VTO system 102 can be configured to receive inference data and/or training data for use in conditioning a plurality of garments simultaneously, brand and/or clothing specific information, and pose information based on natural language inputs. For example, the VTO system 102 can receive the inference data 104 and/or training data 106 as part of a call to an application programming interface (API) exposing the VTO system 102 to one or more computing devices. Inference data and/or training data can also be provided to the VTO system 102 through a storage medium, such as remote storage connected to the one or more computing devices over a network. Inference data 104 and/or training data 106 can further be provided as input through a user interface on a client computing device coupled to the VTO system 102.

The inference data 104 can include data associated with simultaneously conditioning, or warping, garments on a wearer based on brand and/or clothing specific information and pose information. Conditioning garments may include, for example, adjusting the fit, flow, appearance, or the like of the garment based on the intended wearer and/or the intended pose. For example, the garments may be conditioned to fit the intended wearer in a given pose such that the output provides for realistic wrinkles, twists, fit, or the like. Simultaneously conditioning garments may allow for a plurality of garments to be conditioned to an intended wearer such at the same time, rather than one garment at a time. The inference data may be, for example, natural language input describing different types of clothing, brands, poses, environmental details, etc. Types of clothing may include, for examples, a black shirt, blue jeans with rips, white tennis shoes, floral tea length dress, ivory wedding gown with cathedral length train, a teal tuxedo, etc. Different brands may include, for example, Sports Brand X for basketball, Jeans Brand Y for business casual wear, etc. According to some examples, each brand may have additional brand information indicating preferred poses, lighting, environmental details, or the like. Brand information may be provided by the brand as interference data 104 for training the VTO system 102. In some examples, brand information may be inferred from images including the brand and used to for training the VTO system 102. Different poses may include jumping excitedly, jumping for a rebound, standing at an office desk, swimming in a pool, etc. Different environmental details may include, for example, fluorescent lighting, stadium lighting, sunrise on a spring day, photography studio lighting, a sunflower field, etc. The inference data may be provided as input and/or automatically derived from inputs, such as images, to the VTO system 102.

The training data 106 can correspond to an artificial intelligence (AI) or machine learning task for warping, or conditioning, garments on a wearer based on the input garments and/or natural language inputs, such as a task performed by a neural network. The training data 106 can be split into a training set, a validation set, and/or a testing set. An example training/validation/testing split can be an 80/10/10 split, although any other split may be possible. The training data 106 can include examples for simultaneously conditioning garments on a wearer based on the input garments and/or natural language inputs. The natural language inputs may be a description of the garments, pose, environmental conditions, or the like. In some examples, the training data 106 may include one or more images, such as JPEGs, PNGs, or the like, of a wearer, garments, poses, environments, etc. In some examples, the training data 106 may, in addition to or in the alternative, be natural language inputs describing the wearer, garments, pose, environment, etc.

The training data 106 can be in any form suitable for training a model, according to one of a variety of different learning techniques. Learning techniques for training a model can include supervised learning, unsupervised learning, and semi-supervised learning techniques. For example, the training data can include multiple training examples that can be received as input by a model. The training examples can be labeled with a desired output for the model when processing the labeled training examples. The label and the model output can be evaluated through a loss function to determine an error, which can be backpropagated through the model to update weights for the model. For example, if the machine learning task is a classification task, the training examples can be images labeled with one or more classes categorizing subjects depicted in the images. As another example, a supervised learning technique can be applied to calculate an error between outputs, with a ground-truth label of a training example processed by the model. Any of a variety of loss or error functions appropriate for the type of the task the model is being trained for can be utilized, such as cross-entropy loss for classification tasks, or mean square error for regression tasks. The gradient of the error with respect to the different weights of the candidate model on candidate hardware can be calculated, for example using a backpropagation algorithm, and the weights for the model can be updated. The model can be trained until stopping criteria are met, such as a number of iterations for training, a maximum period of time, a convergence, or when a minimum accuracy threshold is met.

From the inference data and/or training data, the VTO system 102 can be configured to output one or more results related to simultaneously conditioning garments on a wearer based on inputs, such as one or more garments and/or natural language inputs. The results may be generated as output data. According to some examples, the output data may be an image of the wearer with intended garments wrapped to the wearer with the wearer in the pose and/or environment as guided by the natural language inputs. In some examples, the pose and/or environment may be guided by the types and/or brands of clothing. As examples, the output data can be any kind of score, classification, or regression output based on the input data. Correspondingly, the AI or machine learning task can be a scoring, classification, and/or regression task for predicting some output given some input. These Al or machine learning tasks can correspond to a variety of different applications in processing images, video, text, speech, or other types of data to simultaneously condition garments to a wearer, adjust the pose of the wearer, and/or adjust environmental details based on inputs into the VTO system 102.

As an example, the VTO system 102 can be configured to send the output data for display on a client or user display. As another example, the VTO system 102 can be configured to provide the output data as a set of computer-readable instructions, such as one or more computer programs. The computer programs can be written in any type of programming language, and according to any programming paradigm, e.g., declarative, procedural, assembly, object-oriented, data-oriented, functional, or imperative. The computer programs can be written to perform one or more different functions and to operate within a computing environment, e.g., on a physical device, virtual machine, or across multiple devices. The computer programs can also implement functionality described herein, for example, as performed by a system, engine, module, or model. The VTO system 102 can further be configured to forward the output data to one or more other devices configured for translating the output data into an executable program written in a computer programming language. The VTO system 102 can also be configured to send the output data to a storage device for storage and later retrieval.

The VTO system 102 can include one or more machine learning layers 110-112. The machine learning layers 110-112 can be implemented as one or more computer programs, specially configured electronic circuitry, or any combination thereof. The machine learning layers 110-112 can be configured to condition garments to a wearer. For example, each machine learning layer 110-112 may be configured to condition a different type of garment, adjust the pose of a wearer, adjust the environmental details, or the like. For example, machine learning layer 110 may be trained to condition, or warp, upper body garments, such as t-shirts, to a wearer, machine learning layer 111 may be trained to condition lower body garments, such as pants, to a wearer, machine learning layer 112 may be trained to condition footwear, such a shoes, to a wearer, etc. Additional layers may include, for example, layers trained to condition accessories, e.g., hats, jewelry, scarves, gloves, etc., outerwear, e.g., jackets, sweatshirts, etc., or the like. Some machine learning layers may be trained based on brands such that the layer is trained to identify the brand in the input garment and adjust the pose and environment details to accentuate, highlight, etc. the brand. In some examples, there may be machine learning layers trained to adjust the pose based on the input garments. For example, if the input garments include running shoes, the machine learning layer may be trained to adjust the pose of the wearer to correspond to a running pose.

By training each machine learning layer to condition different types of garments to the wearer, the input garments may be warped substantially simultaneously rather than sequentially. Additionally, the pose and/or environment details may be adjusted at the same time the garments are warped to the wearer. Accordingly, using a plurality of machine learning layers within the machine learning model, each trained for different types of garments, brands, poses, environment details, etc. may increase the efficiency of the model as compared to using a single machine learning layer of the model to warp the garments, adjust the pose, adjust the environment details, etc. For example, by warping the garments simultaneously and/or adjusting the pose and environment details, the computational efficiency may be increased by utilizing less resources, such as memory and processing power, as the model is processing the inputs once, rather than sequentially, e.g., multiple times.

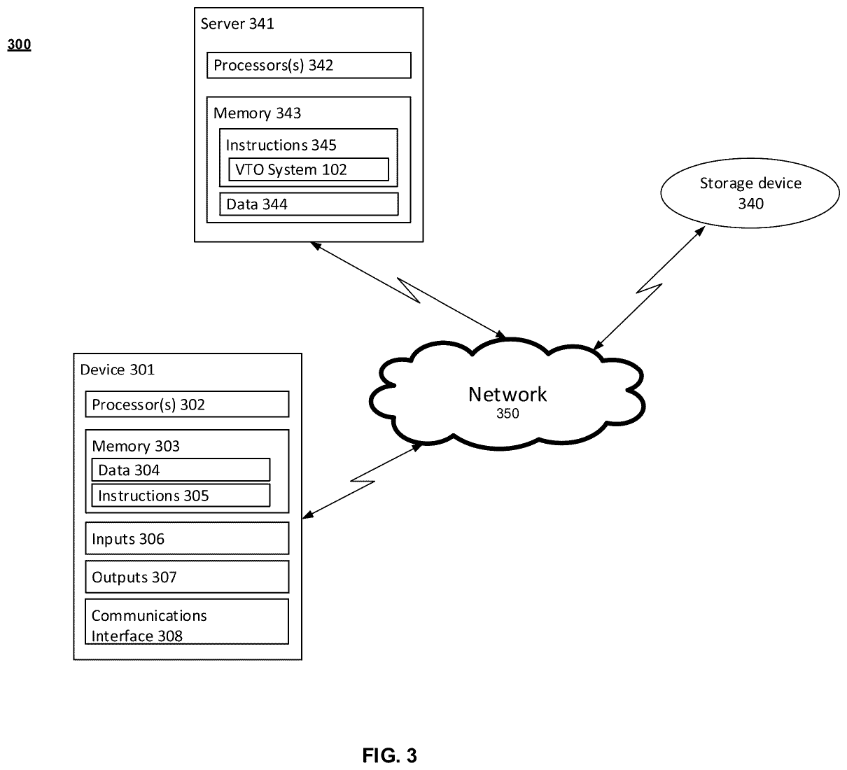

FIG. 3 depicts a block diagram of an example environment for implementing a VTO system. The VTO system 102 can be implemented on one or more devices having one or more processors in one or more locations, such as in server computing device 341. Client computing device 301 and the server computing device 341 can be communicatively coupled to one or more storage devices 340 over a network 350. The storage devices 340 can be a combination of volatile and non-volatile memory and can be at the same or different physical locations than the computing devices. For example, the storage devices 340 can include any type of non-transitory computer readable medium capable of storing information, such as a hard-drive, solid state drive, tape drive, optical storage, memory card, ROM, RAM, DVD, CD-ROM, write-capable, and read-only memories.

The server computing device 341 can include one or more processors 342 and memory 343. The memory 343 can store information accessible by the processors 342, including instructions 345 that can be executed by the processors 342. The memory 343 can also include data 344 that can be retrieved, manipulated, or stored by the processors 342. The memory 343 can be a type of non-transitory computer readable medium capable of storing information accessible by the processors 342, such as volatile and non-volatile memory. The processors 342 can include one or more central processing units (CPUs), graphic processing units (GPUs), field-programmable gate arrays (FPGAs), and/or application-specific integrated circuits (ASICs), such as tensor processing units (TPUs).

The instructions 345 can include one or more instructions that, when executed by the processors 342, cause the one or more processors 342 to perform actions defined by the instructions 345. The instructions 345 can be stored in object code format for direct processing by the processors, or in other formats including interpretable scripts or collections of independent source code modules that are interpreted on demand or compiled in advance. The instructions 345 can include instructions for implementing a VTO system 102, which can correspond to the VTO system 102 of FIG. 1. The VTO system 102 can be executed using the processors 342, and/or using other processors remotely located from the server computing device 341.

The data 344 can be retrieved, stored, or modified by the processors 342 in accordance with the instructions 345. The data 344 can be stored in computer registers, in a relational or non-relational database as a table having a plurality of different fields and records, or as JSON, YAML, proto, or XML documents. The data 344 can also be formatted in a computer-readable format such as, but not limited to, binary values, ASCII, or Unicode. Moreover, the data 344 can include information sufficient to identify relevant information, such as numbers, descriptive text, proprietary codes, pointers, references to data stored in other memories, including other network locations, or information that is used by a function to calculate relevant data.

The client computing device 301 can also be configured similarly to the server computing device 301, with one or more processors 302, memory 303, instructions 305, and data 304. The client computing device 301 can also include a user input 306, a user output 307, and a communications interface 308. The user input 306 can include any appropriate mechanism or technique for receiving input from a user, such as keyboard, mouse, mechanical actuators, soft actuators, touchscreens, microphones, and sensors. The inputs 306 may receive images, natural language inputs, or the like for input into the VTO system 102.

The server computing device 341 can be configured to transmit data to the client computing device 301, and the client computing device 301 can be configured to display at least a portion of the received data on a display implemented as part of the user output 307. The user output 307 can also be used for displaying an interface between the client computing device 301 and the server computing device 341. For example, the output 307 may be a display, such as a monitor having a screen, a touchscreen, a projector, or a television, configured to electronically display information to a user via a graphical user interface (“GUI”) or other types of user interfaces. For example, output 307 may electronically display the output of the VTO system 102, such as an image of the wearer wearing the input garments. The user output 307 can alternatively or additionally include one or more speakers, transducers or other audio outputs, a haptic interface or other tactile feedback that provides non-visual and non-audible information to the platform user of the client computing device.

Device 301 may be at a node of network 350 and capable of directly and indirectly communicating with other nodes of network 350. Although a single device 301 is depicted in FIG. 3, it should be appreciated that a typical system can include one or more computing devices 301, with each computing device being at a different node of network 350.

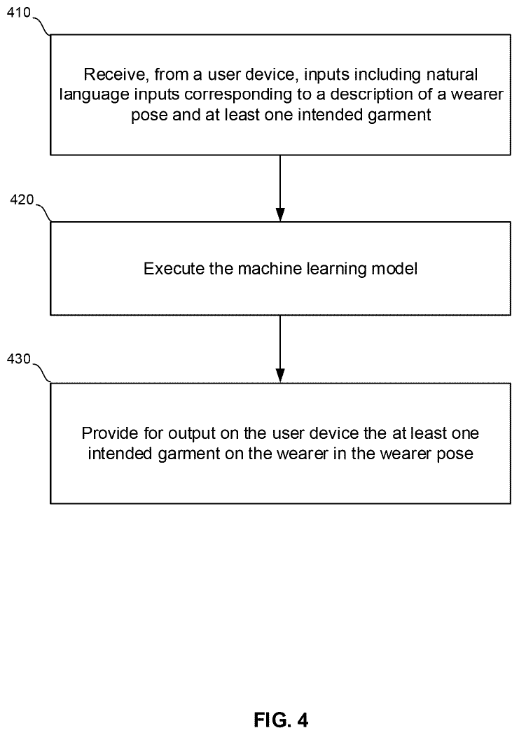

FIG. 4 depicts a flow diagram of an example process for simultaneously conditioning garments on a wearer based on inputs, such as one or more garments and/or natural language inputs. The example process can be performed, at least in part, on a system of one or more processors in one or more locations, such as the VTO system 102 of FIG. 1. The following operations do not have to be performed in the precise order described below. Rather, various operations can be handled in a different order or simultaneously, and operations may be added or omitted.

In block 410, inputs including natural language inputs corresponding to a description of a wearer pose and at least one intended garment may be received from a user device. The te received inputs may be input into a machine learning model. The machine learning model may be a diffusion model that is configured to condition multiple garments simultaneously through a U-Net model.

In block 420, the machine learning model may be executed based on the received inputs. Executing the machine learning model may include adjusting a pose of the wearer based on the natural language inputs corresponding to the description of the wearer pose.

Executing the model may, in some examples, include conditioning, using a respective machine learning layer of the machine learning model, the at least one intended garment to the adjusted pose of the wearer. For example, the machine learning model may comprise one or more machine learning layers. Each machine learning layer may correspond to a type of garment. The types of garments may include, for example, a lower body garment, an upper body garment, an accessory, shoes, or the like. For example, the machine learning model may include a layer for shirts, a layer for pants, a layer for shoes, a layer for gloves, a layer for hats, and so on. In some examples, each machine learning layer, when executed, may provide as output a corresponding garment layer. The garment layer may be, for example, a depiction of the intended garment conditioned, or warped, to the intended wearer in a given pose. According to some examples, the machine learning model may be a diffusion model that allows for the garments to be conditioned and, therefore, warped simultaneously through a U-Net model. Each layer may correspond to a type of garment.

According to some examples, the at least one garment may include two or more intended garments. In such an example, each of the two or more intended garments may be conditioned simultaneously to the adjusted power of the wearer. For example, each of the two or more garments may be simultaneously conditioned using respective machine learning layers of the machine learning model. The respective machine learning layers may be different machine learning layers, e.g., a machine learning layer for an upper body garment, a machine learning layer for a lower body garment, etc. By having a layer conditioned for each type of garment, the garments may be simultaneously conditioned, or warped, to the figure of the wearer in the intended pose, as compared to sequentially warping the garments.

In block 430, an output on the user device may be provided. The output may be the at least one intended garment on the wearer in the wearer pose.

In some examples, the natural language inputs further include environmental details. Environment details may correspond to at least one of lighting, texture, background, color, angle, or image filters. In examples in which the natural language inputs include environmental details, executing the machine learning model may comprise adjusting the environmental details based on the natural language inputs.

According to some examples, the wearer pose and/or environmental details may be adjusted based on brand information. For example, the machine learning model may be trained to adjust the wearer pose and/or environmental details based on brand information. The brand information may include specific angles, lighting, backgrounds, textures, etc. associated with the garments. The brand information may indicate poses and/or environmental details that is most associated with the type of garment. For example, if the brand is a brand of athletic wear for football players, the brand information may include an indication that the lighting should correspond to stadium lighting, the background should be grass or turf, the wearer should be in a crouched position, or the like.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the examples should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

1. A method, comprising:
receiving, by one or more processors from a user device, inputs including natural language inputs corresponding to a description of a wearer pose and at least one intended garment;
executing, by the one or more processors based on the received inputs, a machine learning model, wherein the executing comprises:
adjusting a pose of a wearer based on the natural language inputs corresponding to the description of the wearer pose; and
conditioning, using a respective machine learning layer of the machine learning model, the at least one intended garment to the adjusted pose of the wearer; and
providing for output on the user device, by the one or more processors, the at least one intended garment on the wearer in the wearer pose.

2. The method of claim 1, wherein when the at least one intended garment includes two or more intended garments, each of the two or more intended garments are conditioned simultaneously to the adjusted pose of the wearer.

3. The method of claim 2, wherein:
executing the machine learning model further comprises simultaneously conditioning, using respective machine learning layers of the machine learning model, the two or more intended garments to the adjusted pose of the wearer, the respective machine learning layers being different machine learning layers.

4. The method of claim 1, wherein the natural language inputs further include environmental details, and wherein the output further includes an environment for the wearer based on the environmental details.

5. The method of claim 4, wherein the environmental details correspond to at least one of lighting, texture, background, color, angle, or image filter.

6. The method of claim 4, wherein executing the machine learning model further comprises adjusting an output environment based on the natural language inputs corresponding to the environmental details.

7. The method of claim 1, wherein:
the machine learning model comprises one or more machine learning layers,
each machine learning layer corresponds to a type of garment, and
each machine learning layer, when executed, provides as output a corresponding garment layer.

8. The method of claim 7, wherein the type of garment includes at least one of a lower body garment, an upper body garment, an accessory, or shoes.

9. The method of claim 7, wherein executing the machine learning model further comprises ordering the garment layers based on the received input.

10. The method of claim 1, further comprising
receiving, by the one or more processors, second input; and
executing, by the one or more processors based on the received second input, the machine learning model, wherein executing the machine learning model further comprises:
adjusting a depiction of a second garment in a second garment layer based on the second input.

11. The method of claim 10, wherein adjusting the second garment in the second garment layer does not change the depiction of the at least one intended garment in a first garment layer.

12. The method of claim 10, wherein the second input includes at least one of: an addition of a second intended garment, removal of the intended garment, or an adjustment of an order of the layers of the at least one intended garment.

13. A system, comprising:
one or more processors, the one or more processors configured to:
receive, from a user device, inputs including natural language inputs corresponding to a description of a wearer pose and at least one intended garment;
execute, based on the received inputs, a machine learning model, wherein the executing comprises:
adjusting a pose of a wearer based on the natural language inputs corresponding to the description of the wearer pose; and
conditioning, using a respective machine learning layer of the machine learning model, the at least one intended garment to the adjusted pose of the wearer; and
provide for output on the user device, by the one or more processors, the at least one intended garment on the wearer in the wearer pose.

14. The system of claim 13, wherein when the at least one intended garment includes two or more intended garments, each of the two or more intended garments are conditioned simultaneously to the adjusted pose of the wearer.

15. The system of claim 14, wherein the one or more processors, when executing the machine learning model, are further configured to simultaneously condition, using respective machine learning layers of the machine learning model, the two or more intended garments to the adjusted pose of the wearer, the respective machine learning layers being different machine learning layers.

16. The system of claim 13, wherein the natural language inputs further include environmental details, and wherein the output further includes an environment for the wearer based on the environmental details.

17. The system of claim 16, wherein the environmental details correspond to at least one of lighting, texture, background, color, angle, or image filter.

18. The system of claim 16, wherein executing the machine learning model further comprises adjusting an output environment based on the natural language inputs corresponding to the environmental details.

19. The system of claim 13, wherein:
the machine learning model comprises one or more machine learning layers,
each machine learning layer corresponds to a type of garment, and
each machine learning layer, when executed, provides as output a corresponding garment layer.

20. A non-transitory computer-readable medium storing instructions, which when executed by one or more processors, cause the one or more processors to:
receive, from a user device, inputs including natural language inputs corresponding to a description of a wearer pose and at least one intended garment;
execute, based on the received inputs, a machine learning model, wherein the executing comprises:
adjusting a pose of a wearer based on the natural language inputs corresponding to the description of the wearer pose; and
conditioning, using a respective machine learning layer of the machine learning model, the at least one intended garment to the adjusted pose of the wearer; and
provide for output on the user device, by the one or more processors, the at least one intended garment on the wearer in the wearer pose.
